(19) United States
(12) Patent Application Publication
(10) Pub. No.: US 2025/0185112 A1
(43) Pub. Date: Jun. 5, 2025

(54) FURTHER ENHANCEMENTS IN DRX OPERATION FOR XR AND CLOUD GAMING IN MOBILE COMMUNICATIONS

(71) Applicant: MediaTek Singapore Pte. Ltd., Singapore (SG)

(72) Inventors: Mehmet KUNT, Cambridge (GB); Abdellatif SALAH, Cambridge (GB); Pradeep JOSE, Cambridge (GB); Chi-Hsuan HSIEH, Hsinchu City (TW); Chia-Chun HSU, Hsinchu City (TW)

(21) Appl. No.: 18/842,979

(22) PCT Filed: Apr. 21, 2023
(86) PCT No.: PCT/CN2023/089643

§ 371 Date: Aug. 30, 2024

Related U.S. Application Data
(60) Provisional application No. 63/335,746, filed on Apr. 28, 2022.

(51) Int. Cl. H04W 76/28; H04L 5/00; H04W 76/38

(52) U.S. Cl. CPC H04W 76/28; H04L 5/0044; H04W 76/38

(57) ABSTRACT

Techniques and solutions pertaining to further enhancements in discontinuous reception (DRX) operation for extended reality (XR) and cloud gaming in mobile communications are described. An apparatus (e.g., user equipment (UE)) enters a DRX mode in wireless communications. The apparatus controls at least one timer or at least one on-duration occasion to reduce DRX cycle mismatch or UE power consumption due to jitter when in the DRX mode.

### CROSS REFERENCE TO RELATED PATENT APPLICATION(S)

The present disclosure is part of a non-provisional application claiming the priority benefit of U.S. Patent Application No. 63/335,746, filed 28 Apr. 2022, the content of which herein being incorporated by reference in its entirety.

### TECHNICAL FIELD

The present disclosure is generally related to mobile communications and, more particularly, to further enhancements in discontinuous reception (DRX) operation for extended reality (XR) and cloud gaming in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), applications and services with strict latency and high bandwidth requirements, such as XR applications and cloud gaming, are emerging and becoming more prevalent. However, there remain some issues that need to be addressed. One issue pertains to the DRX cycle mismatch with a quasi-periodic XR traffic. This is because legacy DRX cycle values do not match the periodicity (or quasi-periodicity) of typical XR traffic. Over time, the difference could build up and the DRX on-duration (herein interchangeably referred to as “On-Duration”) could be completely outside of (e.g., out of synchronization with) a jitter period. Another issue pertains to jitter for XR traffic/cloud gaming as the jitter can be large (e.g., [−4, +4] milliseconds) for XR and cloud gaming traffic. Even assuming the DRX cycle mismatch issue is resolved, covering the entire jitter period with On-Duration could have a large impact on the power consumption of a user equipment (UE). On the other hand, in case that the On-Duration is smaller than the jitter, some downlink (DL) data might be delayed until a next on-duration. Therefore, there is a need for a solution of further enhancements in DRX operation for XR and cloud gaming in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving further enhancements in DRX operation for XR and cloud gaming in mobile communications. It is believed that, under the various proposed schemes, aforementioned issues related to DRX cycle mismatch and jitter for XR traffic/cloud gaming may be avoided, reduced or otherwise alleviated.

In one aspect, a method may involve a UE entering a DRX mode in wireless communications. The method may also involve the UE controlling at least one timer or at least one on-duration occasion to reduce DRX cycle mismatch or UE power consumption due to jitter when in the DRX mode.

In another aspect, an apparatus implementable in a UE may include a transceiver configured to communicate wirelessly and a processor coupled to the transceiver. The processor may enter the UE into a DRX mode in wireless communications. The processor may also control at least one timer or at least one on-duration occasion to reduce DRX cycle mismatch or UE power consumption due to jitter when in the DRX mode.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a block diagram of an example communication system in accordance with an implementation of the present disclosure.

FIG. 10 is a flowchart of an example process in accordance with an implementation of the present disclosure.

FIG. 11 is a flowchart of an example process in accordance with an implementation of the present disclosure.

FIG. 12 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to further enhancements in DRX operation for XR and cloud gaming in mobile communications in mobile communications. According to the present disclosure, a number of possible solutions may be implemented separately or jointly. That is, although these possible solutions may be described below separately, two or more of these possible solutions may be implemented in one combination or another.

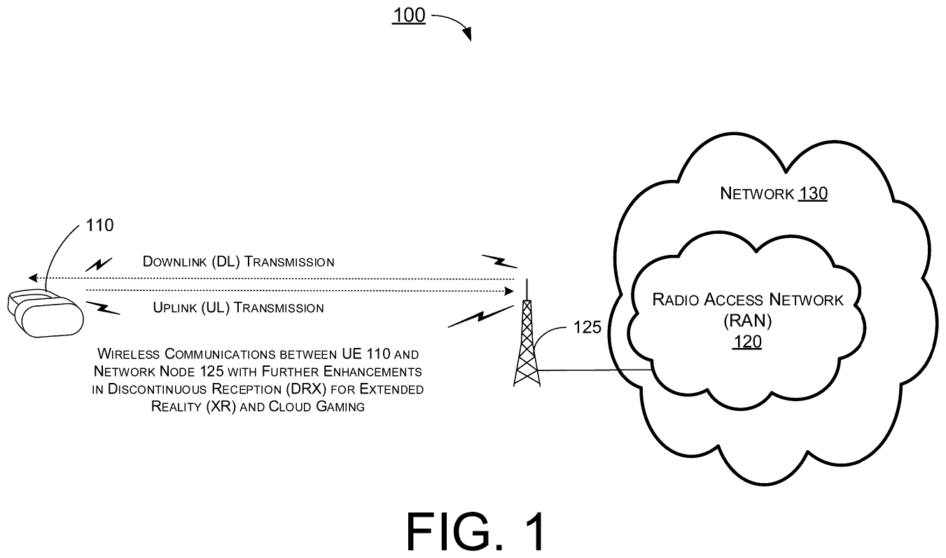

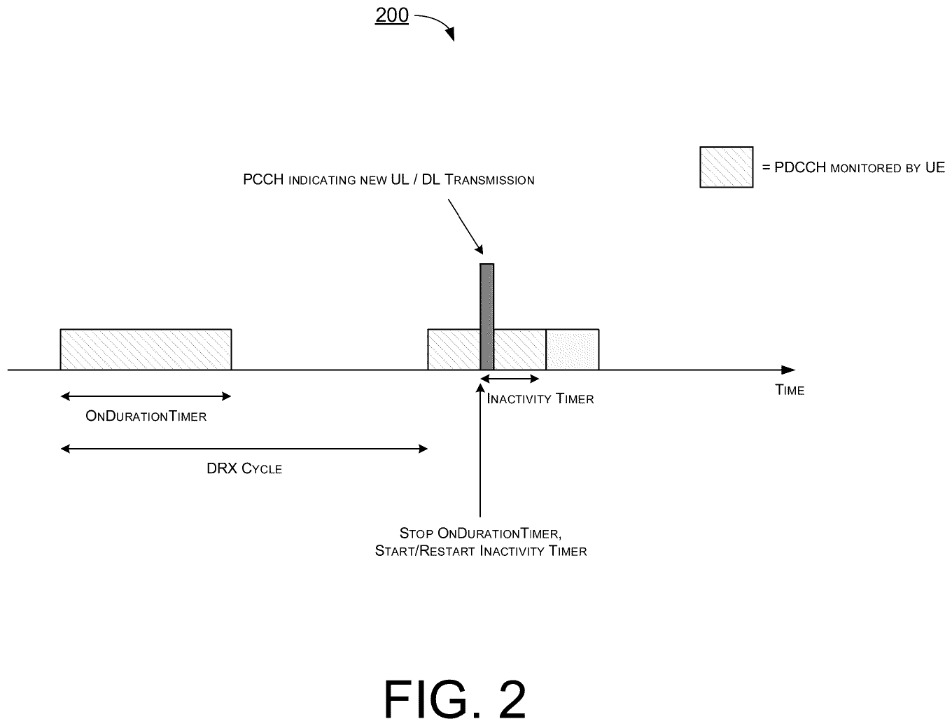

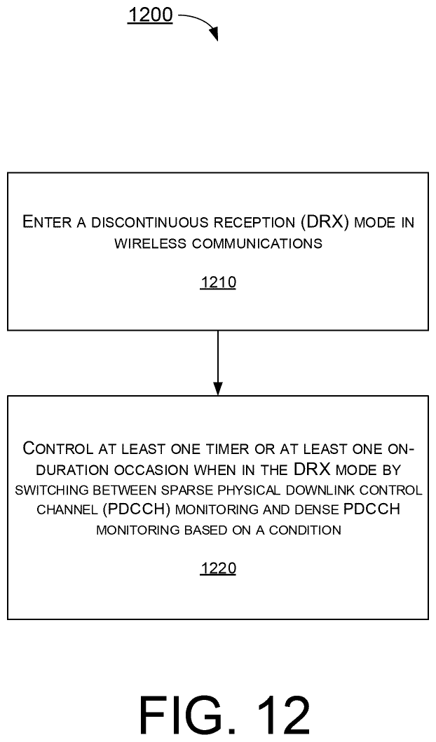

FIG. 1 illustrates an example network environment 100 in which various solutions and schemes in accordance with the present disclosure may be implemented. FIG. 2˜FIG. 12 illustrate examples of implementation of various proposed schemes in network environment 100 in accordance with the present disclosure. The following description of various proposed schemes is provided with reference to FIG. 1˜FIG. 12.

Referring to FIG. 1, network environment 100 may involve a UE 110 in wireless communication with a RAN 120 (e.g., a 5G NR mobile network or another type of network such as an NTN). UE 110 may be in wireless communication with RAN 120 via a base station or network node 125 (e.g., an eNB, gNB or transmit-receive point (TRP)). RAN 120 may be a part of a network 130. In network environment 100, UE 110 and network 130 (via network node 125 of RAN 120) may implement various schemes pertaining to further enhancements in DRX operation for XR and cloud gaming in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

FIG. 2 illustrates an example scenario 200 under a first proposed scheme in accordance with the present disclosure. Referring to FIG. 2, a DRX on-duration timer (herein interchangeably referred to as “OnDurationTimer” and “ODT”) may be stopped when any of a number of conditions is met. Such conditions may include, for example and without limitation: (1) a physical downlink control channel (PDCCH) is received and indicates a new uplink (UL) or DL transmission; (2) a new DL transmission (on a physical downlink shared channel (PDSCH)) is received or a new UL transmission (on a physical uplink shared channel (PUSCH)) is performed; and (3) every time a DRX inactivity timer (herein interchangeably referred to as “drx-InactivityTimer” and “InactivityTimer”) is started. It is noteworthy that the conditions for UL transmission may be used to cover the case where network 130 is sending unsolicited dynamic grants (DGs) to UE 110. The UL grants may indicate to UE 110 to stop monitoring the PDCCH for a current On-Duration.

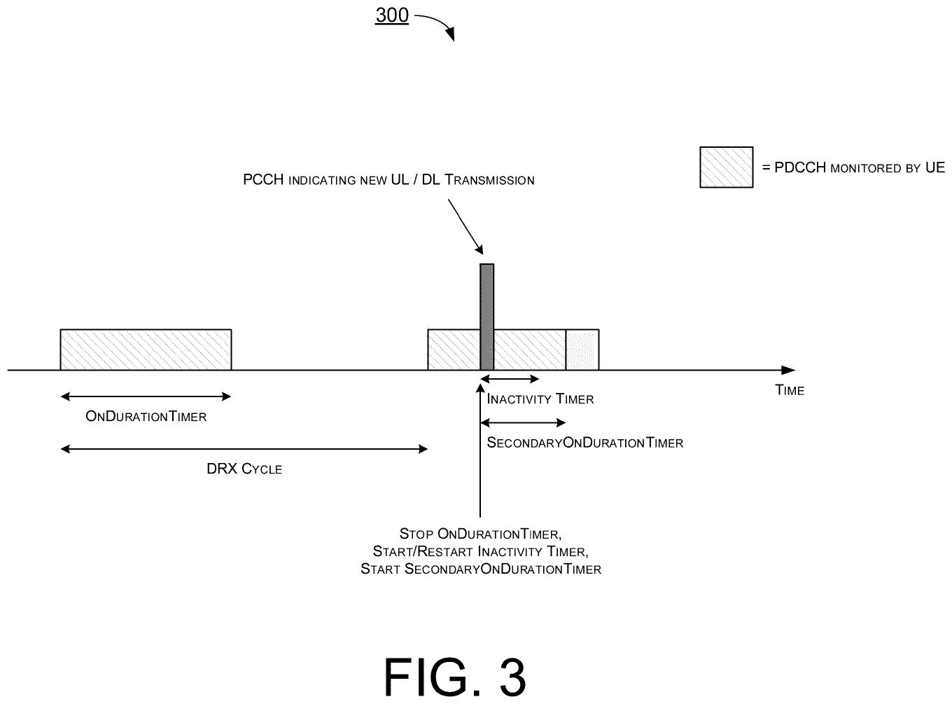

FIG. 3 illustrates an example scenario 300 under a second proposed scheme in accordance with the present disclosure. Under the second proposed scheme, when a PDCCH for UL or DL transmission is received or when a new DL or UL transmission is received or performed (as in the first proposed scheme described above), one other timer may be started after stopping the OnDurationTimer. This other timer may be referred to as a “SecondaryOnDurationTimer” or “SODT” herein. Referring to FIG. 3, the SODT may have a smaller value or duration than that of the ODT. Additionally, the SODT may be started only for the first PDCCH/data arriving during the OnDuration but, unlike the InactivityTimer, the SODT is not restarted for subsequent arrival of data. Moreover, UE 110 may be in Active Time (e.g., monitoring the PDCCH) when the SODT is running.

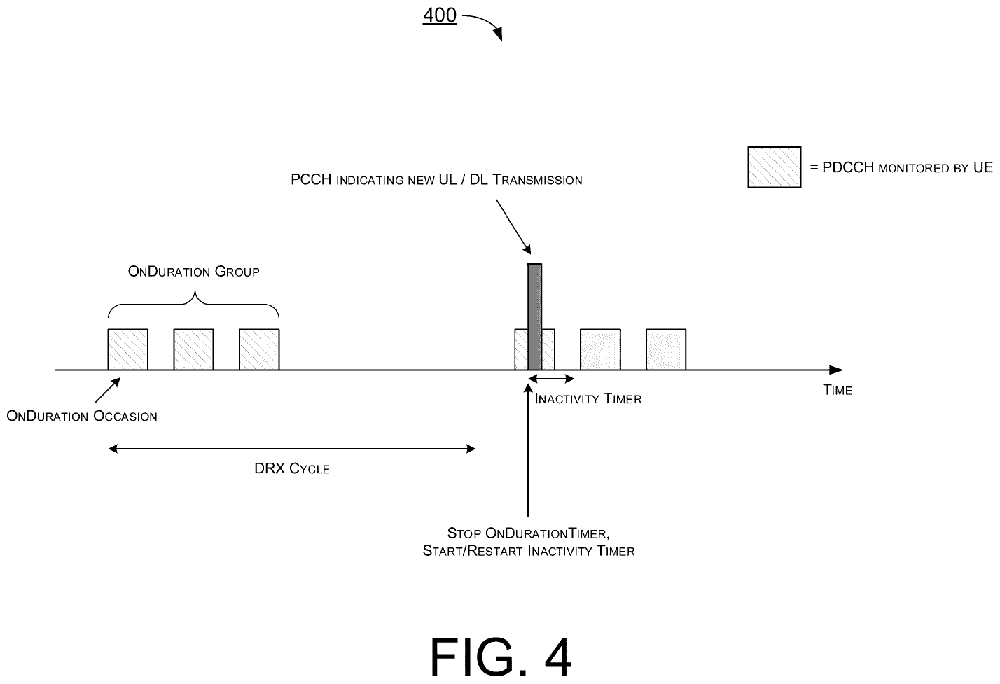

FIG. 4 illustrates an example scenario 400 under a third proposed scheme in accordance with the present disclosure. Under the third proposed scheme, groups of DRX on-durations may be defined in a new way. Referring to FIG. 4, UE 110 may skip the OnDuration occasions in a current group when any of a number of conditions is met. Such conditions may include, for example and without limitation: (1) the PDCCH is received and indicates a new UL or DL transmission; (2) a new DL transmission (on the PDSCH) is received or a new UL transmission (on the PUSCH) is performed; and (3) every time the InactivityTimer is started. Under the third proposed scheme, the ODT for the current OnDuration occasion may be stopped or kept running. Alternatively, the ODT may be stopped but other OnDuration occasions in the current group may remain active (e.g., not skipped).

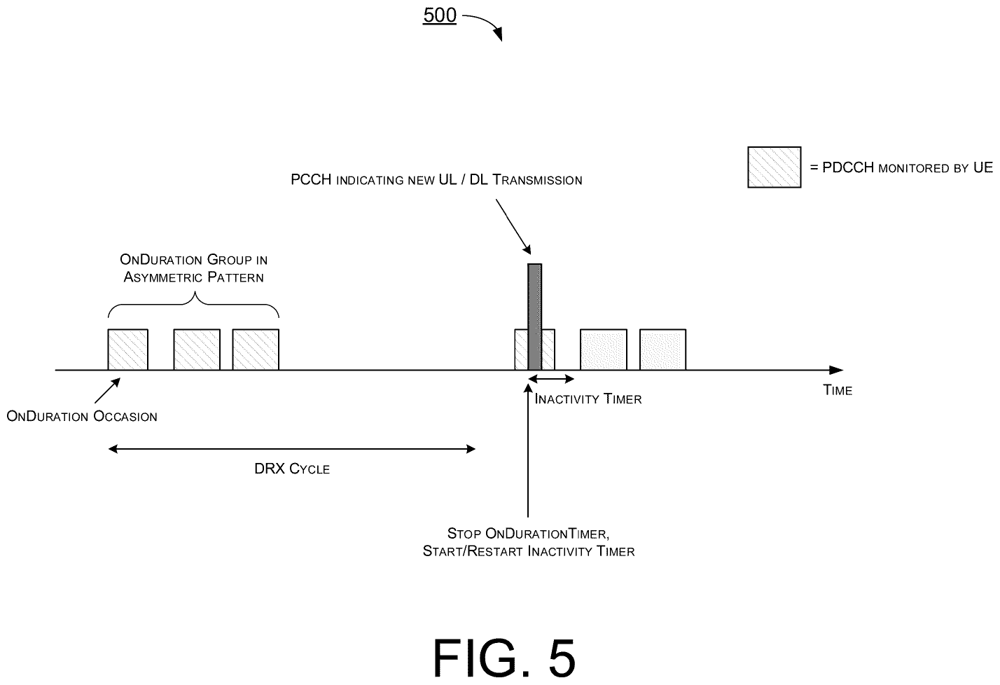

FIG. 5 illustrates an example scenario 500 under a fourth proposed scheme in accordance with the present disclosure. Under the fourth proposed scheme, groups of DRX on-durations or on-durations in a given group may be defined or otherwise distributed in an asymmetric pattern in the time domain. Referring to FIG. 5, an illustrative and non-limiting asymmetric pattern may be as follows: 2 ms OnDuration, 2 ms gap, 4 ms OnDuration, 1 ms gap, 3 ms OnDuration. That is, the durations of at least two on-duration occasions in a given group of on-duration occasions may be different. Additionally, or alternatively, a first gap between a first pair of two adjacent on-duration occasions and a second gap between a second pair of two different adjacent on-duration occasions may be different. Advantageously, this proposed scheme may be useful to UE 110 for being able to receive data approaching a delay budget (e.g., packet delay budget (PDB)).

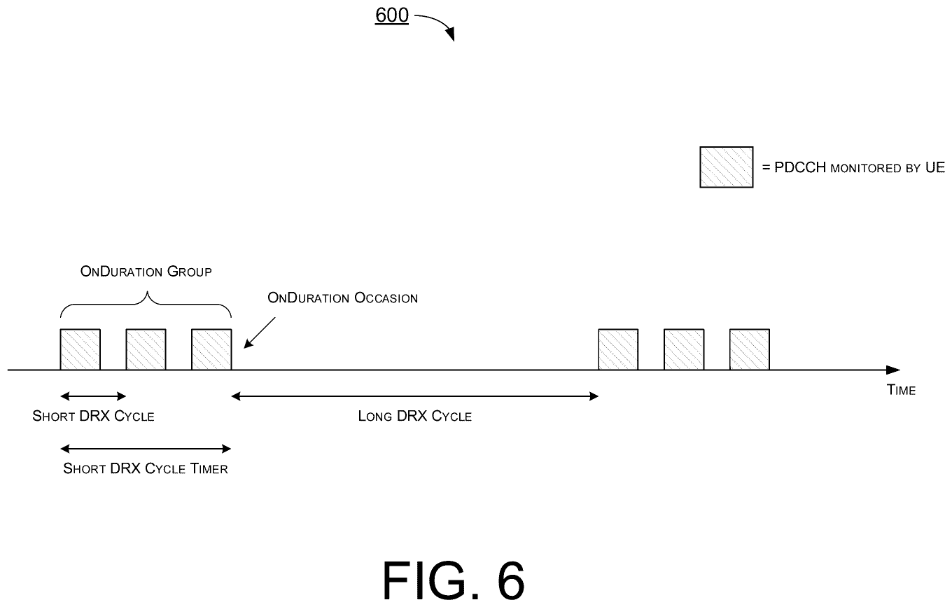

FIG. 6 illustrates an example scenario 600 under a fifth proposed scheme in accordance with the present disclosure. Under the fifth proposed scheme, groups of DRX on-durations may be realized using an existing short DRX cycle and long DRX cycle mechanisms with some enhancements. Referring to FIG. 6, when a short DRX cycle timer expires, UE 110 may switch to a long DRX cycle. At the next OnDuration occasion, or after a number of OnDuration occasions, UE 110 may switch back to the short DRX cycle and start the short DRX timer. Optionally, when the PDCCH for a new DL or UL transmission is received, or when the first new DL or UL data transmission is received or performed, UE 110 may switch to the long DRX cycle (e.g., sparse PDCCH monitoring).

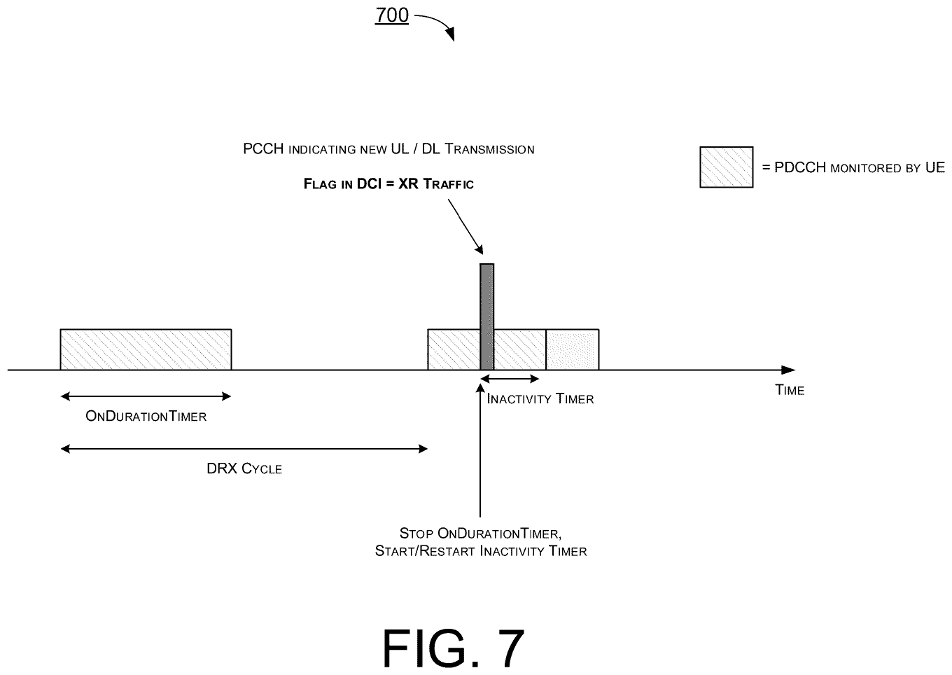

FIG. 7 illustrates an example scenario 700 under a sixth proposed scheme in accordance with the present disclosure. Under the sixth proposed scheme, downlink control information (DCI) signaling from network 130 may indicate to UE 110 regarding when to apply or otherwise implement one or more of aforementioned proposed schemes. Referring to FIG. 7, one or more fields in the DCI may indicate XR and/or cloud gaming or other special traffic (e.g., a flag being set when the traffic associated with the DCI is of a certain type of traffic). Based on the field(s) in the DCI, UE 110 may apply or otherwise implement one or more of aforementioned proposed schemes. Alternatively, behavior(s) according to one or more aforementioned proposed schemes may be default behavior(s) of UE 110 and the field(s) in the DCI may indicate that UE 110 is not to apply such behavior(s) for that DCI, for a current OnDuration, or for a current OnDuration group (current group of OnDuration occasions).

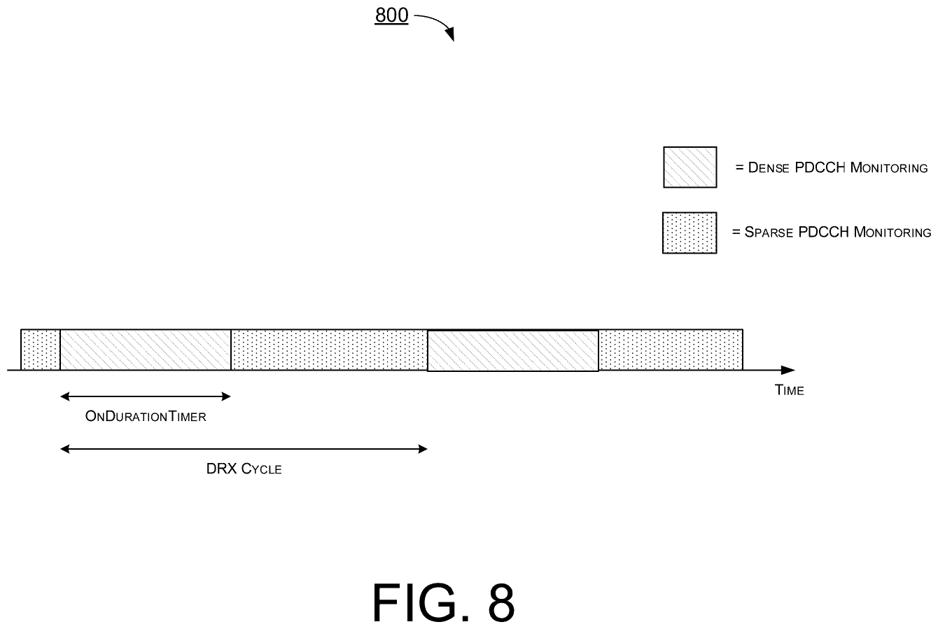

FIG. 8 illustrates an example scenario 800 under a seventh proposed scheme in accordance with the present disclosure. Under the seventh proposed scheme, UE 110 may switch between sparse and dense PDCCH monitoring profiles (e.g., on different search space set groups (SSSGs)) based on any of a number of conditions. Such conditions may include, for example and without limitation: (1) if UE 110 is in Active Time; (2) only if the DRX OnDuration timer is running; (3) only if the DRX Inactivity timer is running; and (4) only if the DRX OnDuration timer or Inactivity timer is running.

### Illustrative Implementations

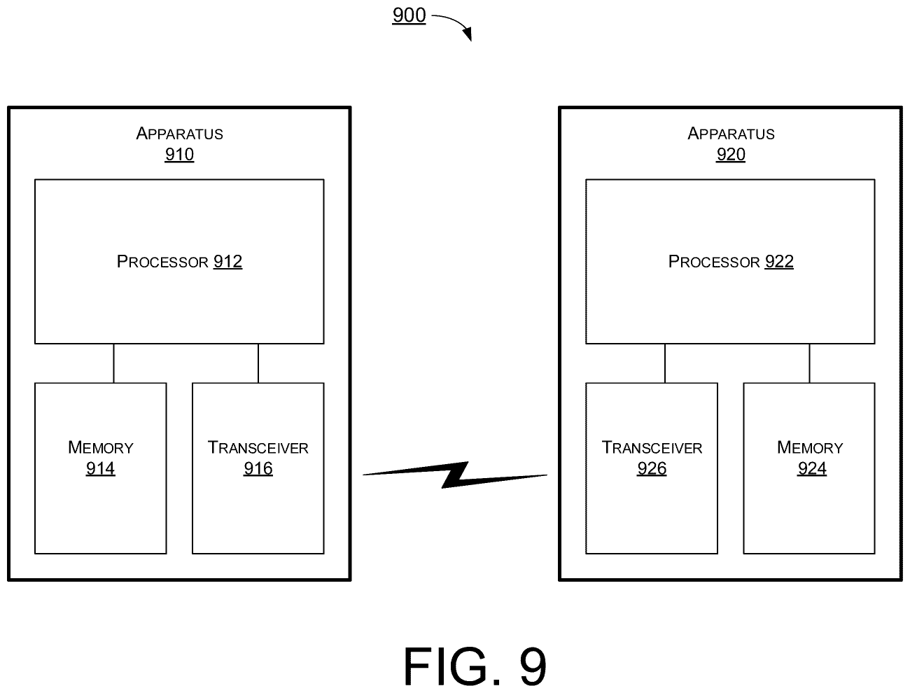

FIG. 9 illustrates an example communication system 900 having at least an example apparatus 910 and an example apparatus 920 in accordance with an implementation of the present disclosure. Each of apparatus 910 and apparatus 920 may perform various functions to implement schemes, techniques, processes and methods described herein pertaining to further enhancements in DRX operation for XR and cloud gaming in mobile communications in mobile communications, including the various schemes described above with respect to various proposed designs, concepts, schemes, systems and methods described above, including network environment 100, as well as processes described below.

Each of apparatus 910 and apparatus 920 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 910 and apparatus 920 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 910 and apparatus 920 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 910 and apparatus 920 may be implemented in a smart thermostat, a smart fridge, a smart door lock, a wireless speaker or a home control center. When implemented in or as a network apparatus, apparatus 910 and/or apparatus 920 may be implemented in an eNodeB in an LTE, LTE-Advanced or LTE-Advanced Pro network or in a gNB or TRP in a 5G network, an NR network or an IoT network. In some implementations, each of apparatus 910 and apparatus 920 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 910 and apparatus 920 may be implemented in or as a network apparatus or a UE. Each of apparatus 910 and apparatus 920 may include at least some of those components shown in FIG. 9 such as a processor 912 and a processor 922, respectively, for example. Each of apparatus 910 and apparatus 920 may further include one or more other components not pertinent to the proposed scheme of the present disclosure (e.g., internal power supply, display device and/or user interface device), and, thus, such component(s) of apparatus 910 and apparatus 920 are neither shown in FIG. 9 nor described below in the interest of simplicity and brevity.

In one aspect, each of processor 912 and processor 922 may be implemented in the form of one or more single-core processors, one or more multi-core processors, or one or more CISC or RISC processors. That is, even though a singular term “a processor” is used herein to refer to processor 912 and processor 922, each of processor 912 and processor 922 may include multiple processors in some implementations and a single processor in other implementations in accordance with the present disclosure. In another aspect, each of processor 912 and processor 922 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 912 and processor 922 is a special-purpose machine specifically designed, arranged and configured to perform specific tasks including those pertaining to further enhancements in DRX operation for XR and cloud gaming in mobile communications in accordance with various implementations of the present disclosure.

In some implementations, apparatus 910 may also include a transceiver 916 coupled to processor 912. Transceiver 916 may be capable of wirelessly transmitting and receiving data. In some implementations, transceiver 916 may be capable of wirelessly communicating with different types of wireless networks of different radio access technologies (RATs). In some implementations, transceiver 916 may be equipped with a plurality of antenna ports (not shown) such as, for example, four antenna ports. That is, transceiver 916 may be equipped with multiple transmit antennas and multiple receive antennas for multiple-input multiple-output (MIMO) wireless communications. In some implementations, apparatus 920 may also include a transceiver 926 coupled to processor 922. Transceiver 926 may include a transceiver capable of wirelessly transmitting and receiving data. In some implementations, transceiver 926 may be capable of wirelessly communicating with different types of UEs/wireless networks of different RATs. In some implementations, transceiver 926 may be equipped with a plurality of antenna ports (not shown) such as, for example, four antenna ports. That is, transceiver 926 may be equipped with multiple transmit antennas and multiple receive antennas for MIMO wireless communications.

In some implementations, apparatus 910 may further include a memory 914 coupled to processor 912 and capable of being accessed by processor 912 and storing data therein. In some implementations, apparatus 920 may further include a memory 924 coupled to processor 922 and capable of being accessed by processor 922 and storing data therein. Each of memory 914 and memory 924 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 914 and memory 924 may include a type of read-only memory (ROM) such as mask ROM, programmable ROM (PROM), erasable programmable ROM (EPROM) and/or electrically erasable programmable ROM (EEPROM). Alternatively, or additionally, each of memory 914 and memory 924 may include a type of non-volatile random-access memory (NVRAM) such as flash memory, solid-state memory, ferroelectric RAM (FeRAM), magnetoresistive RAM (MRAM) and/or phase-change memory.

Each of apparatus 910 and apparatus 920 may be a communication entity capable of communicating with each other using various proposed schemes in accordance with the present disclosure. For illustrative purposes and without limitation, a description of capabilities of apparatus 910, as a UE (e.g., UE 110), and apparatus 920, as a network node (e.g., network node 125 or another network node implementing one or more network-side functionalities described above) of an application server side network (e.g., network 130 as a 5G/NR mobile network), is provided below.

Under various proposed schemes in accordance with the present disclosure pertaining to further enhancements in DRX operation for XR and cloud gaming in mobile communications, processor 912 of apparatus 910, implemented in or as a UE (e.g., UE 110) may enter a DRX mode in wireless communications. Moreover, processor 912 may control, via transceiver 916, at least one timer or at least one on-duration occasion to reduce DRX cycle mismatch or UE power consumption due to jitter when in the DRX mode.

In some implementations, in controlling the at least one timer, processor 912 may stop an on-duration timer responsive to a condition being met. In some implementations, the condition may include any one of the following: (1) a PDCCH being received and indicating a new UL transmission or a new DL transmission; or (2) the new DL transmission being received on a PDSCH or the new UL transmission being performed on a PUSCH; or (3) a DRX inactivity timer being started.

In some implementations, responsive to the PDCCH for the new UL or DL transmission having been received or the new UL or DL transmission having been received or performed, in controlling the at least one timer, processor 912 may start a secondary on-duration timer after stopping the on-duration timer. In some implementations, the secondary on-duration timer may have a smaller value or duration than that of the on-duration timer. Moreover, in starting the secondary on-duration timer, processor 912 may start the secondary on-duration timer for a first PDCCH or data arriving during a DRX on-duration. Additionally, processor 912 may monitor the PDCCH when the secondary on-duration timer is running.

In some implementations, in controlling the at least one on-duration occasion, processor 912 may skip one or more on-duration occasions in a current group of on-duration occasions responsive to a condition being met. In some implementations, the condition may include any one of the following: (1) a PDCCH being received and indicating a new UL transmission or a new DL transmission; or (2) the new DL transmission being received on a PDSCH or the new UL transmission being performed on a PUSCH; or (3) a DRX inactivity timer being started. In some implementations, in controlling the at least one on-duration occasion, processor 912 may keep an on-duration timer for a current on-duration occasion in the current group of on-duration occasions running. In some implementations, in controlling the at least one on-duration occasion, processor 912 may also stop an on-duration timer for a current on-duration occasion in the current group of on-duration occasions. Moreover, in controlling the at least one on-duration occasion, processor 912 may keep one or more other on-duration occasions in the current group of on-duration occasions active.

In some implementations, a plurality of on-duration occasions in a current group of on-duration occasions may be distributed in an asymmetric pattern in time.

In some implementations, in controlling the at least one on-duration occasion, processor 912 may perform certain operations. For instance, processor 912 may utilize a short DRX cycle between two or more on-duration occasions in a first group of on-duration occasions. Moreover, processor 912 may utilize a long DRX cycle between the first group of on-duration occasions and a second group of on-duration occasions.

In some implementations, in controlling the at least one on-duration occasion, processor 912 may switch from a short DRX cycle to a long DRX cycle responsive to a condition being met. In some implementations, the condition may include any one of the following: (1) a PDCCH being received and indicating a new UL transmission or a new DL transmission; or (2) the new DL transmission being received on a PDSCH or the new UL transmission being performed on a PUSCH.

In some implementations, in controlling, processor 912 may perform certain operations. For instance, processor 912 may receive a DCI indicating a specific type of traffic. Additionally, processor 912 may control the at least one timer or the at least one on-duration occasion responsive to receiving the DCI. In some implementations, a field in the DCI may indicate the specific type of traffic being a traffic for XR or cloud gaming.

In some implementations, in controlling, processor 912 may switch between sparse PDCCH monitoring and dense PDCCH monitoring based on a condition. In some implementations, the condition may include any one of the following: (1) a UE being in Active Time; (2) in case of a DRX on-duration timer running; or (3) in case of a DRX inactivity timer running.

### Illustrative Processes

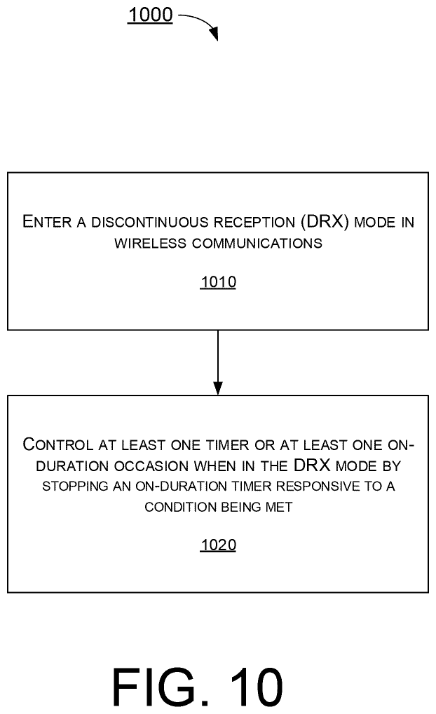

FIG. 10 illustrates an example process 1000 in accordance with an implementation of the present disclosure. Process 1000 may represent an aspect of implementing various proposed designs, concepts, schemes, systems and methods described above, whether partially or entirely, including those pertaining to those described above. More specifically, process 1000 may represent an aspect of the proposed concepts and schemes pertaining to further enhancements in DRX operation for XR and cloud gaming in mobile communications in mobile communications. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively in a different order. Furthermore, one or more of the blocks/sub-blocks of process 1000 may be executed iteratively. Process 1000 may be implemented by or in apparatus 910 and apparatus 920 as well as any variations thereof. Solely for illustrative purposes and without limiting the scope, process 1000 is described below in the context of apparatus 910 as a UE (e.g., UE 110) and apparatus 920 as a communication entity such as a network node or base station (e.g., network node 125 or another network node implementing one or more network-side functionalities described above) of an application server side network (e.g., network 130). Process 1000 may begin at block 1010.

At 1010, process 1000 may involve processor 912 of apparatus 910, implemented in or as a UE (e.g., UE 110) entering a DRX mode in wireless communications. Process 1000 may proceed from 1010 to 1020.

At 1020, process 1000 may involve processor 912 controlling, via transceiver 916, at least one timer or at least one on-duration occasion to reduce DRX cycle mismatch or UE power consumption due to jitter when in the DRX mode.

In some implementations, in controlling the at least one timer, process 1000 may involve processor 912 stopping an on-duration timer responsive to a condition being met. In some implementations, the condition may include any one of the following: (1) a PDCCH being received and indicating a new UL transmission or a new DL transmission; or (2) the new DL transmission being received on a PDSCH or the new UL transmission being performed on a PUSCH; or (3) a DRX inactivity timer being started.

In some implementations, responsive to the PDCCH for the new UL or DL transmission having been received or the new UL or DL transmission having been received or performed, in controlling the at least one timer, process 1000 may also involve processor 912 starting a secondary on-duration timer after stopping the on-duration timer. In some implementations, the secondary on-duration timer may have a smaller value or duration than that of the on-duration timer. Moreover, in starting the secondary on-duration timer, process 1000 may involve processor 912 starting the secondary on-duration timer for a first PDCCH or data arriving during a DRX on-duration. Additionally, process 1000 may also involve processor 912 monitoring the PDCCH when the secondary on-duration timer is running.

In some implementations, in controlling, process 1000 may involve processor 912 performing certain operations. For instance, process 1000 may involve processor 912 receiving a DCI indicating a specific type of traffic. Additionally, process 1000 may involve processor 912 controlling the at least one timer or the at least one on-duration occasion responsive to receiving the DCI. In some implementations, a field in the DCI may indicate the specific type of traffic being a traffic for XR or cloud gaming.

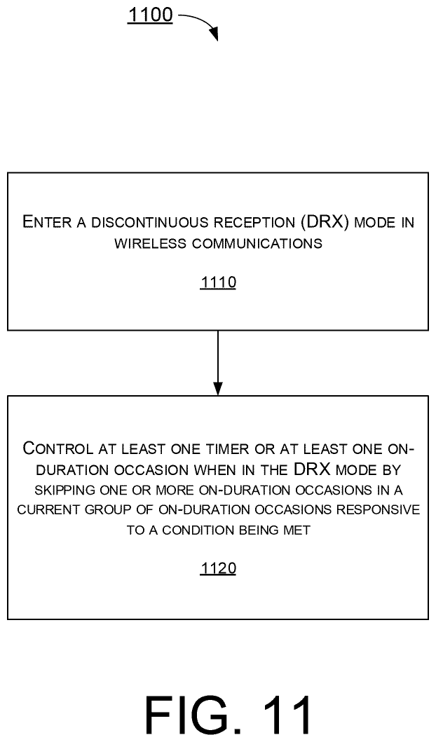

FIG. 11 illustrates an example process 1100 in accordance with an implementation of the present disclosure. Process 1100 may represent an aspect of implementing various proposed designs, concepts, schemes, systems and methods described above, whether partially or entirely, including those pertaining to those described above. More specifically, process 1100 may represent an aspect of the proposed concepts and schemes pertaining to further enhancements in DRX operation for XR and cloud gaming in mobile communications in mobile communications. Process 1100 may include one or more operations, actions, or functions as illustrated by one or more of blocks 1110 and 1120. Although illustrated as discrete blocks, various blocks of process 1100 may be divided into additional blocks, combined into fewer blocks, or eliminated, depending on the desired implementation. Moreover, the blocks/sub-blocks of process 1100 may be executed in the order shown in FIG. 11 or, alternatively in a different order. Furthermore, one or more of the blocks/sub-blocks of process 1100 may be executed iteratively. Process 1100 may be implemented by or in apparatus 910 and apparatus 920 as well as any variations thereof. Solely for illustrative purposes and without limiting the scope, process 1100 is described below in the context of apparatus 910 as a UE (e.g., UE 110) and apparatus 920 as a communication entity such as a network node or base station (e.g., network node 125 or another network node implementing one or more network-side functionalities described above) of an application server side network (e.g., network 130). Process 1100 may begin at block 1110.

At 1110, process 1100 may involve processor 912 of apparatus 910, implemented in or as a UE (e.g., UE 110) entering a DRX mode in wireless communications. Process 1100 may proceed from 1110 to 1120.

At 1120, process 1100 may involve processor 912 controlling, via transceiver 916, at least one timer or at least one on-duration occasion to reduce DRX cycle mismatch or UE power consumption due to jitter when in the DRX mode.

In some implementations, in controlling the at least one on-duration occasion, process 1100 may involve processor 912 skipping one or more on-duration occasions in a current group of on-duration occasions responsive to a condition being met. In some implementations, the condition may include any one of the following: (1) a PDCCH being received and indicating a new UL transmission or a new DL transmission; or (2) the new DL transmission being received on a PDSCH or the new UL transmission being performed on a PUSCH; or (3) a DRX inactivity timer being started.

In some implementations, in controlling the at least one on-duration occasion, process 1100 may also involve processor 912 keeping an on-duration timer for a current on-duration occasion in the current group of on-duration occasions running. In some implementations, in controlling the at least one on-duration occasion, process 1100 may further involve processor 912 stopping an on-duration timer for a current on-duration occasion in the current group of on-duration occasions. Moreover, in controlling the at least one on-duration occasion, process 1100 may further involve processor 912 keeping one or more other on-duration occasions in the current group of on-duration occasions active.

In some implementations, a plurality of on-duration occasions in a current group of on-duration occasions may be distributed in an asymmetric pattern in time.

In some implementations, in controlling the at least one on-duration occasion, process 1100 may involve processor 912 performing certain operations. For instance, process 1100 may involve processor 912 utilizing a short DRX cycle between two or more on-duration occasions in a first group of on-duration occasions. Moreover, process 1100 may involve processor 912 utilizing a long DRX cycle between the first group of on-duration occasions and a second group of on-duration occasions.

In some implementations, in controlling the at least one on-duration occasion, process 1100 may involve processor 912 switching from a short DRX cycle to a long DRX cycle responsive to a condition being met. In some implementations, the condition may include any one of the following: (1) a PDCCH being received and indicating a new UL transmission or a new DL transmission; or (2) the new DL transmission being received on a PDSCH or the new UL transmission being performed on a PUSCH.

FIG. 12 illustrates an example process 1200 in accordance with an implementation of the present disclosure. Process 1200 may represent an aspect of implementing various proposed designs, concepts, schemes, systems and methods described above, whether partially or entirely, including those pertaining to those described above. More specifically, process 1200 may represent an aspect of the proposed concepts and schemes pertaining to further enhancements in DRX operation for XR and cloud gaming in mobile communications in mobile communications. Process 1200 may include one or more operations, actions, or functions as illustrated by one or more of blocks 1210 and 1220. Although illustrated as discrete blocks, various blocks of process 1200 may be divided into additional blocks, combined into fewer blocks, or eliminated, depending on the desired implementation. Moreover, the blocks/sub-blocks of process 1200 may be executed in the order shown in FIG. 12 or, alternatively in a different order. Furthermore, one or more of the blocks/sub-blocks of process 1200 may be executed iteratively. Process 1200 may be implemented by or in apparatus 910 and apparatus 920 as well as any variations thereof. Solely for illustrative purposes and without limiting the scope, process 1200 is described below in the context of apparatus 910 as a UE (e.g., UE 110) and apparatus 920 as a communication entity such as a network node or base station (e.g., network node 125 or another network node implementing one or more network-side functionalities described above) of an application server side network (e.g., network 130). Process 1200 may begin at block 1210.

At 1210, process 1200 may involve processor 912 of apparatus 910, implemented in or as a UE (e.g., UE 110) entering a DRX mode in wireless communications. Process 1200 may proceed from 1210 to 1220.

At 1220, process 1200 may involve processor 912 controlling, via transceiver 916, at least one timer or at least one on-duration occasion to reduce DRX cycle mismatch or UE power consumption due to jitter when in the DRX mode.

In some implementations, in controlling, process 1200 may involve processor 912 switching between sparse PDCCH monitoring and dense PDCCH monitoring based on a condition. In some implementations, the condition may include any one of the following: (1) a UE being in Active Time; (2) in case of a DRX on-duration timer running; or (3) in case of a DRX inactivity timer running.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
entering a discontinuous reception (DRX) mode in wireless communications; and
controlling at least one timer or at least one on-duration occasion when in the DRX mode,
wherein the controlling of the at least one timer comprises stopping an on-duration timer responsive to a condition being met, and
wherein the condition comprises:
a physical downlink control channel (PDCCH) being received and indicating a new uplink (UL) transmission or a new downlink (DL) transmission; or
the new DL transmission being received on a physical downlink shared channel (PDSCH) or the new UL transmission being performed on a physical uplink shared channel (PUSCH); or
a DRX inactivity timer being started.

2. The method of claim 1, wherein, responsive to the PDCCH for the new UL or DL transmission having been received or the new UL or DL transmission having been received or performed, the controlling of at least one timer further comprises starting a secondary on-duration timer after stopping the on-duration timer.

3. The method of claim 2, wherein the secondary on-duration timer has a smaller value or duration than that of the on-duration timer.

4. The method of claim 2, wherein the starting of the secondary on-duration timer comprises starting the secondary on-duration timer for a first PDCCH or data arriving during a DRX on-duration.

5. The method of claim 2, further comprising:
monitoring the PDCCH when the secondary on-duration timer is running.

6. The method of claim 1, wherein the controlling further comprises:
receiving a downlink control information (DCI) indicating a specific type of traffic; and
controlling the at least one timer or the at least one on-duration occasion responsive to receiving the DCI.

7. The method of claim 6, wherein a field in the DCI indicates the specific type of traffic being a traffic for extended reality (XR) or cloud gaming.

8. A method, comprising:
entering a discontinuous reception (DRX) mode in wireless communications; and
controlling at least one timer or at least one on-duration occasion when in the DRX mode,
wherein the controlling of the at least one on-duration occasion comprises skipping one or more on-duration occasions in a current group of on-duration occasions responsive to a condition being met, and
wherein the condition comprises:
a physical downlink control channel (PDCCH) being received and indicating a new uplink (UL) transmission or a new downlink (DL) transmission; or
the new DL transmission being received on a physical downlink shared channel (PDSCH) or the new UL transmission being performed on a physical uplink shared channel (PUSCH); or
a DRX inactivity timer being started.

9. The method of claim 8, wherein the controlling of the at least one on-duration occasion further comprises keeping an on-duration timer for a current on-duration occasion in the current group of on-duration occasions running.

10. The method of claim 8, wherein the controlling of the at least one on-duration occasion further comprises stopping an on-duration timer for a current on-duration occasion in the current group of on-duration occasions.

11. The method of claim 8, wherein the controlling of the at least one on-duration occasion further comprises keeping one or more other on-duration occasions in the current group of on-duration occasions active.

12. The method of claim 8, wherein a plurality of on-duration occasions in a current group of on-duration occasions are distributed in an asymmetric pattern in time.

13. The method of claim 8, wherein the controlling of the at least one on-duration occasion further comprises:
utilizing a short DRX cycle between two or more on-duration occasions in a first group of on-duration occasions; and
utilizing a long DRX cycle between the first group of on-duration occasions and a second group of on-duration occasions.

14. The method of claim 8, wherein the controlling of the at least one on-duration occasion further comprises switching from a short DRX cycle to a long DRX cycle responsive to a condition being met.

15. The method of claim 14, wherein the condition further comprises:
a physical downlink control channel (PDCCH) being received and indicating a new uplink (UL) transmission or a new downlink (DL) transmission; or
the new DL transmission being received on a physical downlink shared channel (PDSCH) or the new UL transmission being performed on a physical uplink shared channel (PUSCH).

16. A method, comprising:
entering a discontinuous reception (DRX) mode in wireless communications; and
controlling at least one timer or at least one on-duration occasion when in the DRX mode,
wherein the controlling comprises switching between sparse physical downlink control channel (PDCCH) monitoring and dense PDCCH monitoring based on a condition.

17. The method of claim 16, wherein the condition comprises:
a user equipment (UE) being in Active Time; or
a DRX on-duration timer running; or
a DRX inactivity timer running.
